(19) United States
(12) Patent Application Publication
(10) Pub. No.: US 2020/0037104 A1
(43) Pub. Date: Jan. 30, 2020

(54) SYSTEM AND METHOD FOR LOCATION-BASED CHAT COMMUNICATIONS

(71) Applicant: Life on Queen Inc., Toronto (CA)

(72) Inventor: David Weiss, Toronto (CA)

(73) Assignee: Life on Queen Inc., Toronto (CA)

(21) Appl. No.: 16/186,552

(22) Filed: Nov. 11, 2018

Related U.S. Application Data
(60) Provisional application No. 62/702,405, filed on Jul. 24, 2018.

(51) Int. Cl. H04W 4/02; H04L 12/58; H04W 4/21; H04L 29/08

(52) U.S. Cl. CPC H04W 4/023; H04L 51/32; H04L 67/306; H04L 51/12; H04W 4/21

(57) ABSTRACT

Disclosed is a method of forming a social network, including receiving from an initiator device an initiation signal; receiving an initiator user profile associated with the initiator device; monitoring an area around the initiator device to detect a target device indicating ongoing interest in forming new social networks and located within a target area; notifying the initiator user and providing the initiator with a target user profile; and transmitting an initiating communication between the devices. Also disclosed is a system for social networking, including a radio transceiver; a display; a storage; and a processor configured to direct the radio transceiver to search for a target device indicating an availability to form a social network and located within a threshold distance of the radio transceiver, the processor further configured to retrieve target user profile information from the target device and provide the target user profile information to the display.

### FIELD OF THE INVENTION

The present specification relates generally to location-based networking, and specifically to a system and method for location-based social networking.

### BACKGROUND OF THE INVENTION

Many users of computing devices employ their computing devices to interact with users of other computing devices. For example, a user may connect with other users directly by calling, texting, or otherwise contacting others whom they are able to identify using a known phone number or email address or other addressing information. As another example, a user may connect with other users through a social networking service implemented over the Internet.

Often, social networking efforts benefit from proximity among networkers, as many participants in social networks appreciate an element of face-to-face contact in their relationships. While building a social network with nearby individuals over time may be appealing, in many cases a user of a social networking service simply wishes to find an easy way to connect with people who are near the user in the moment.

### SUMMARY OF THE INVENTION

In an embodiment of the present invention, there is provided a method of forming a social network, comprising receiving an initiator status signal from an initiator device, the initiator status signal indicating interest in forming the social network; receiving an initiator user profile of an initiator user, the initiator user profile associated with the initiator device; receiving a target status signal from a target device, the target status signal indicating ongoing interest in receiving notifications about potential new social networks; receiving a target user profile of a target user, the target user profile associated with the target device; determining that a distance between the initiator device and the target device is less than a threshold; sending the target user profile to the initiator device to be reviewed by the initiator user; receiving a social network communication from the initiator device directed to the target device; and providing the social network communication to the target device along with the initiator user profile.

In an embodiment of the present invention, there is provided a method of forming a social network, comprising receiving from an initiator device an initiation signal indicating an interest in forming the social network; receiving an initiator user profile of an initiator user, the initiator user profile associated with the initiator device; monitoring an area around the initiator device to detect a target device indicating ongoing interest in forming new social networks and located within a target area, the target area bounded by a threshold distance from the initiator device; notifying the initiator user of the target device and providing the initiator with a target user profile associated with the target device; and transmitting an initiating communication from the initiator device to the target device.

In an embodiment of the present invention, there is provided a system for social networking, comprising a radio transceiver for sending and receiving a set of short-range radio transmissions; a display for displaying system notifications to a user; a storage for storing the set of short-range radio transmissions; and a processor configured to direct the radio transceiver to search for a target device indicating an availability to form a social network and located within a threshold distance of the radio transceiver, the processor further configured to retrieve target user profile information from the target device and provide the target user profile information to the display.

### BRIEF DESCRIPTION OF THE DRAWINGS

The principles of the invention may better be understood with reference to the accompanying figures provided by way of illustration of an exemplary embodiment, or embodiments, incorporating principles and aspects of the present invention, and in which:

FIG. 1 shows a screenshot of a welcome screen, according to an embodiment;

FIG. 2 shows a screenshot of a proximity screen, according to an embodiment;

FIG. 3 shows a screenshot of a proximity screen, according to an embodiment;

FIG. 4 shows a screenshot of a proximity screen showing a confirmation request message, according to an embodiment;

FIGS. 5A, 5B, 5C, 5D, 5E, and 5F show a series of screenshots showing user interaction options, according to an embodiment;

FIGS. 6A, 6B, and 6C show a series of screenshots showing group chat options, according to an embodiment;

FIG. 7 shows a screenshot of a chats summary screen, according to an embodiment;

FIG. 8 shows a screenshot of a history summary screen, according to an embodiment;

FIG. 9 shows a screenshot of a profile setting screen, according to an embodiment;

FIG. 10 is a flow diagram of steps in the creation of a social network, according to an embodiment;

FIG. 11 shows a system for generating a social network, for use with embodiments of the invention; and

FIG. 12 shows a computer system for use with embodiments of the invention.

### DETAILED DESCRIPTION OF THE EMBODIMENTS

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order more clearly to depict certain features of the invention.

An aspect of this description relates to a networking system provided to allow users to initiate new social networks with nearby fellow users of the networking system who have indicated an interest in participating in new social networks.

An aspect of this description relates to the use of direct short-range radio transmissions to initiate a social network. An aspect of this description relates to the use of direct short-range radio transmissions to locate user devices and pass messages between user devices. Examples of short-range radio transmissions include those described by various Bluetooth transmission standards.

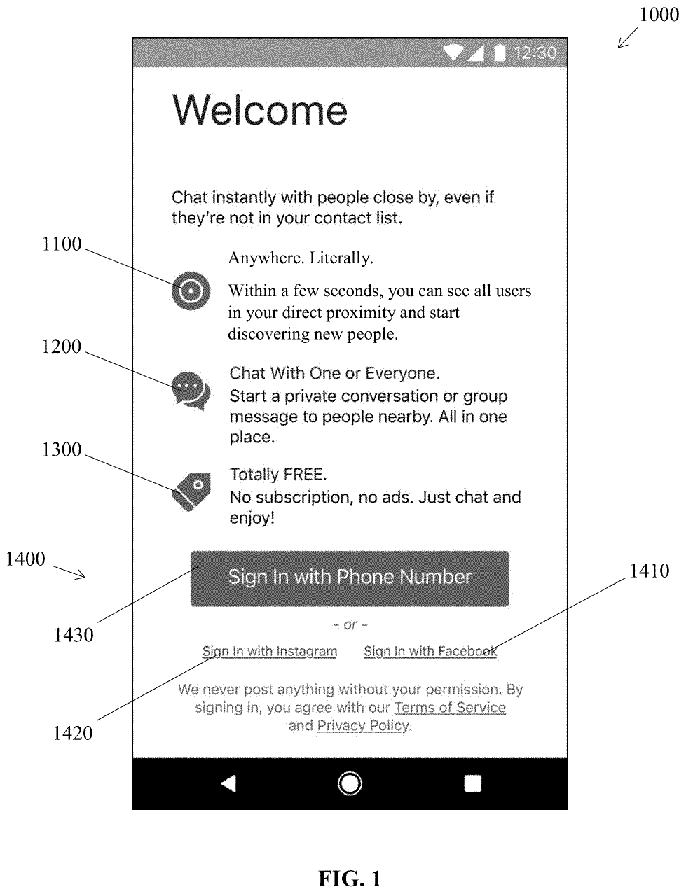

In an embodiment, a networking system is provided for use with personal mobile devices such as smartphones. A user interface is provided to allow a user to interact with this networking system and to participate in forming a new social network. FIG. 1 depicts a screenshot 1000 of this user interface. Screenshot 1000 is a welcome screen for introducing a user to the networking system. Screenshot 1000 shows a set of messages 1100, 1200, and 1300 to inform a user of certain features of the networking system.

As depicted in FIG. 1, a user is invited to sign into the networking system through the welcome screen. Sign in options 1400 include options for signing in with existing social media accounts 1410 and 1420 or signing in directly using the phone number of their personal mobile device 1430. Signing in directly using a phone number 1430 allows a user to create new social networks, which may be entirely unconnected to their existing social networks. However, even where existing social media accounts are used, new social networks may be formed using the networking system and may coexist with or be added to existing social networks.

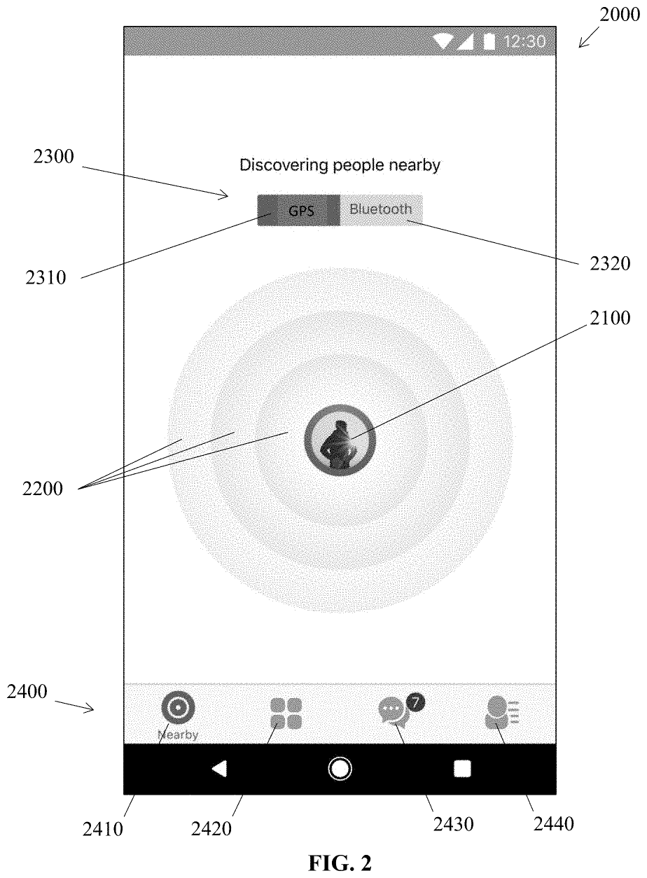

As indicated in screenshot 2000 of FIG. 2, when a user has signed into the networking system through welcome screen 1000 of FIG. 1 they have access to a proximity screen showing other users of the networking system who are located near the user. Screenshot 2000 indicates that no other users are in the immediate proximity of initiating user 2100. Initiating user 2100 is shown surrounded by a set of proximity rings 2200 provided to allow the initiating user to more easily visually differentiate between the relative or absolute proximity of nearby potential target users.

The proximity screen also includes a service option indicator 2300 indicating how proximity is being detected. In screenshot 2000, the service option indicator 2300 indicates that the networking system is using GPS or Internet services to provide proximity information. The GPS or Internet icon 2310 is highlighted, while the Bluetooth icon 2320 is not highlighted.

When a user wishes to detect other users using a short-range low-power radio transceiver in their own device to detect users directly without obtaining proximity information via a GPS service or over an Internet server, the user has the option of switching to a Bluetooth or similar service option, such as by selecting the Bluetooth icon 2320. While determining proximity using GPS or other Internet-delivered information may be highly convenient or practical in some situations, in other situations where an Internet connection is not available, such as in a subway station or on a plane, the use of direct detection of nearby devices may be more convenient or practical. Even where an Internet connection is available, the use of direct detection may be preferable, such as for a more secure connection or as a way of being more certain that the potential target user is in fact within a predetermined threshold distance.

In some embodiments, when a user is using a Bluetooth or similar service option, the setting on their personal mobile device may be automatically set to permit the networking system to use the necessary features of the personal mobile device, such as to activate and use a radio transceiver provided in their personal mobile device.

In some embodiments, when a user has indicated a desire to have an installed social networking application use Bluetooth, their device is configured to broadcast messages having an identifier, such as a universally unique identifier (‘QUID’), over Bluetooth to nearby devices. Nearby receiving devices, which have a corresponding social networking application installed and in which Bluetooth functionality is enabled, will be configured to receive the messages. The receiving devices will be configured to parse identifiers in the messages to determine that the sending device has the social networking application installed, and the receiving device will then indicate, on the receiving device's proximity screen, the presence of the sending device.

In some embodiments, broadcasts of availability messages are intermittent to reduce battery usage. In some embodiments, searching for broadcasts is also intermittent to reduce battery usage.

In some embodiments, Bluetooth low energy (‘BLE’) technology is used. As a result, devices are not paired. Instead, a connection is created, and the connection is dropped if one or more termination conditions is met, such as the screen of a participating device being turned off or the application of a participating device losing focus. Embodiments may use standard Bluetooth and BLE protocols. In some embodiments, BLE is used, and one of a sending device and a receiving device may act as a central device with the other acting as a peripheral, or both may act as standard central devices or both as peripheral devices with or without one or more further devices.

In some embodiments, security protocols follow standard Bluetooth security protocols. In some embodiments, both the receiving and sending devices communicate by broadcasting CBUUIDs. CBUUIDs are unique identifiers that are used in BLE communication. Each peripheral, service, and characteristic has its own CBUUID. By specifying what service a device is looking for, it can be directed to ignore all peripherals which do not advertise that service and to return a list of peripherals which do offer that service. A specific message is then sent by a receiving device that has parsed a UUID to a sending device to indicate that the receiving device has the required security settings before a connection is established to send and receive data and other messages.

In some embodiments, if the user wishes to stop Bluetooth functionality, they may toggle to GPS or Internet searching which will both end the message broadcasts of their own device and stop their device from searching for messages from other devices. In some embodiments, searching and broadcasting are controlled by separate toggles. In some embodiments, toggling a Bluetooth feature in the networking application does not affect Bluetooth availability outside the application.

In some embodiments, the user's device may still be set to receive a message and communicate via Bluetooth or a similar service option even if they themselves have set their networking system to use Internet or GPS services, such as to receive an initiating message from another user via Bluetooth and to continue the communication with that other user using Bluetooth.

As indicated on the bottom of screenshot 2000, a user interface of the networking system may also provide a user with a number of navigation options 2400 provided with a variety of screens. A proximity screen icon 2410 can be used by the user to pull up a proximity screen such as depicted in FIG. 2, a menu icon 2420 can be used by the user to pull up a main menu screen such as a menu providing the user with navigation options to various other screens, a messages icon 2430 can be used by the user to pull up a summary screen showing various conversations that a user has participated in and is participating in, and a profile icon 2440 can be used by the user to pull up a profile screen allowing the user to view or update their own profile.

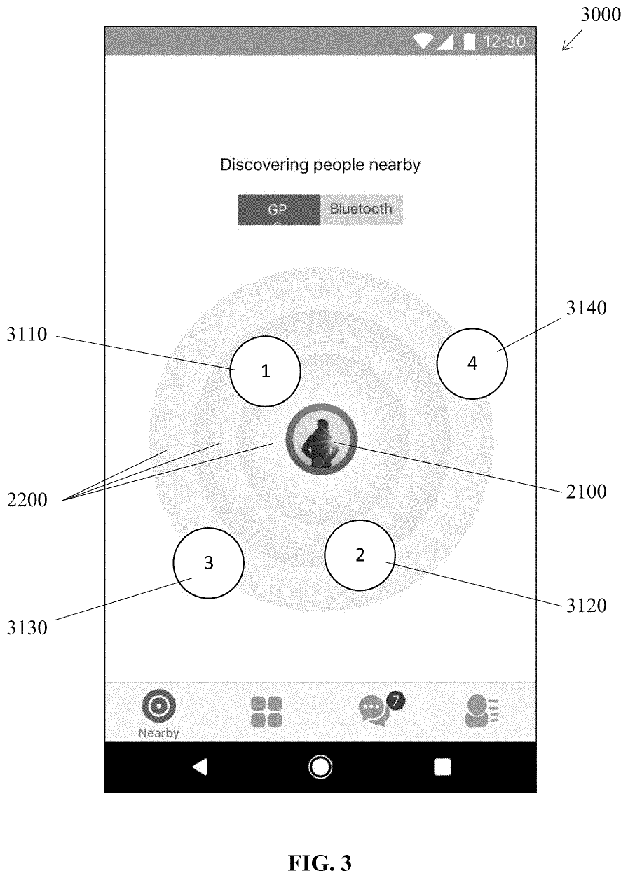

FIG. 3 also shows the proximity screen of the interface of the networking system. FIG. 3 shows screenshot 3000 which indicates that four potential target users 3110, 3120, 3130, and 3140 are near initiating user 2100. Using the information about the proximity of the potential target users, initiating user 2100 can decide whether or not to initiate a conversation with one or all or a subset of the potential target users. A proximity screen may also provide profile information from the potential target users to the initiating user 2100, such as one or more of a name, a photo, and a comment from the potential target user.

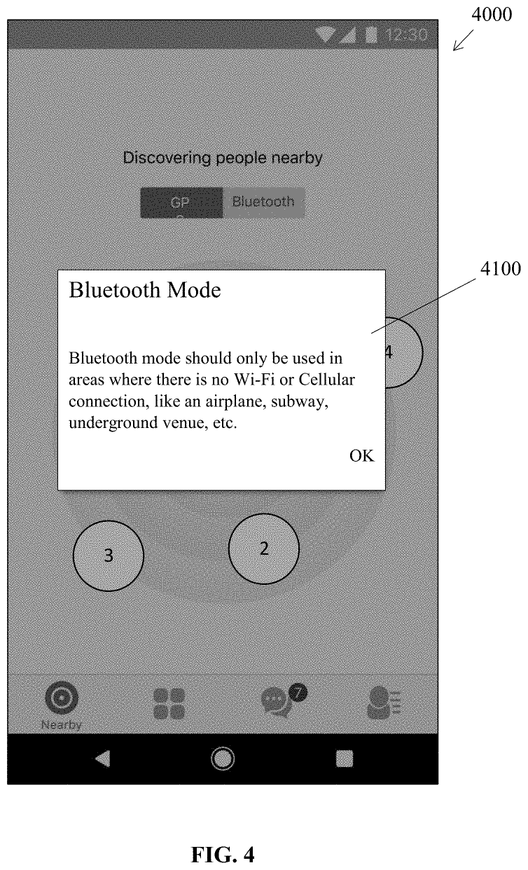

As indicated in FIG. 4, if a user selects an icon for direct detection of proximate users, such as Bluetooth icon 2320 of FIG. 2, they may be asked to confirm that they wish to switch to direct detection. Screenshot 4000 shows a confirmation request message 4100 asking the user to confirm the switch to Bluetooth.

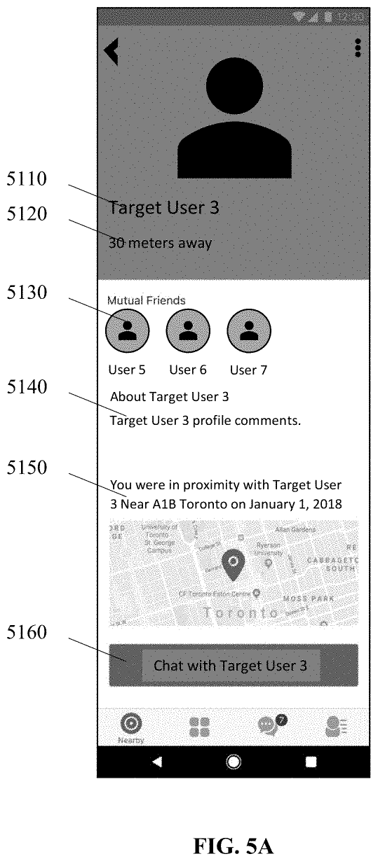

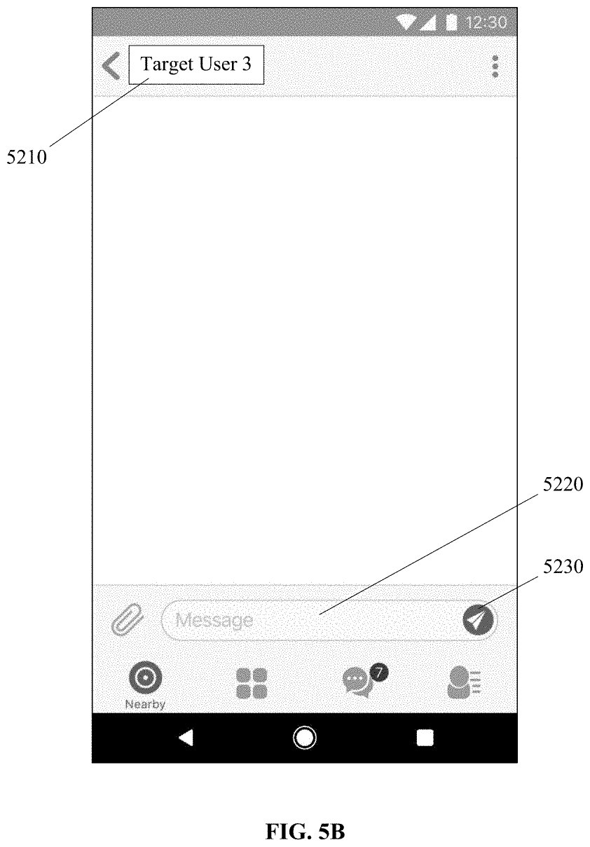

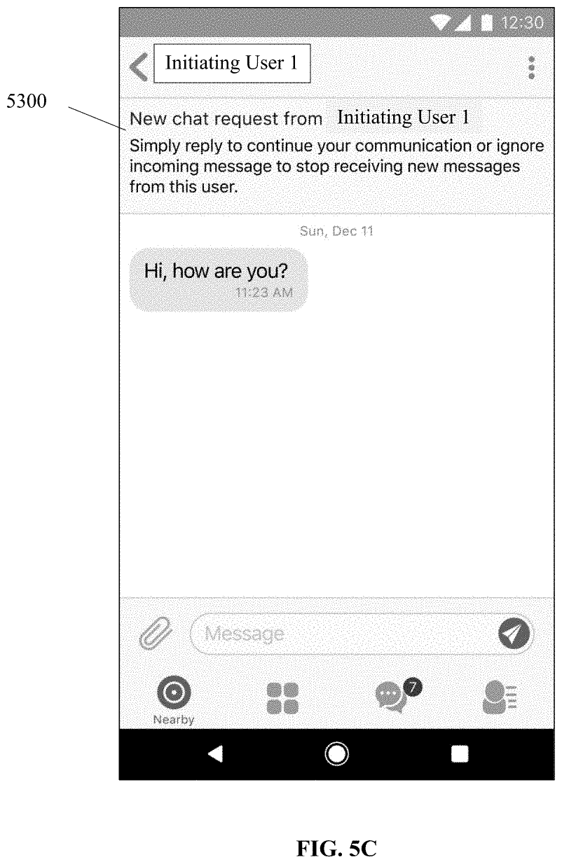

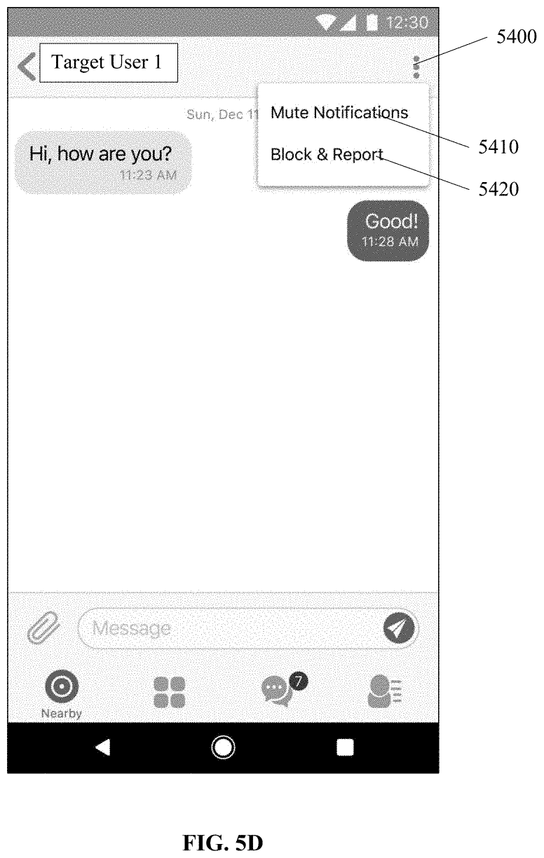

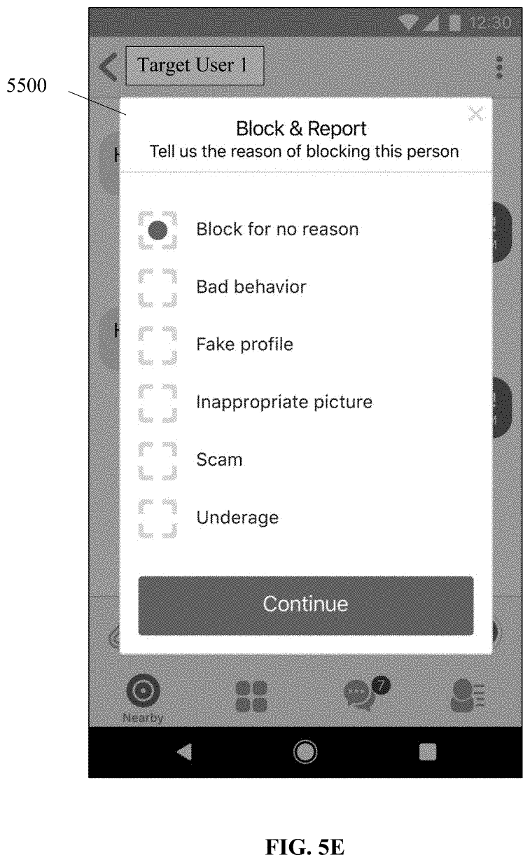

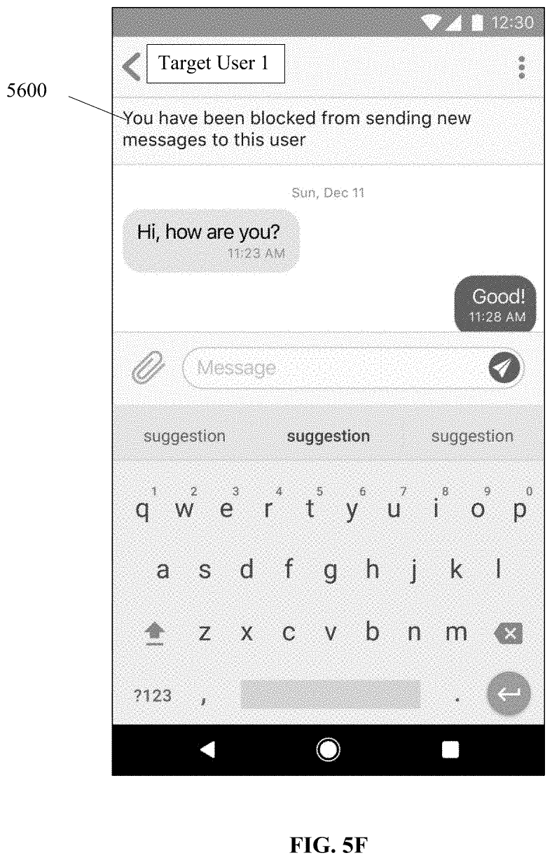

FIGS. 5A to 5F show a series of screenshots showing interaction options. Having accessed a proximity screen, an initiating user may see someone that the initiating user is interested in forming a social network with. The initiating user may then choose to view the selected target user's profile, such as to learn more about the target user, to learn more about existing connections between the initiating user and the target user such as mutual friends, or to learn about any past interactions or encounters with the target user. For example, FIG. 5A shows a target user profile summary screen, such as the profile of potential target user 3130 of FIG. 4. The profile summary screen includes a section 5110 to indicate the name of the target user, a section 5120 to indicate the distance to the target user, a section 5130 to indicate existing connections between the initiating user and the target user, a section 5140 to display profile comments provided by the target user, a section 5150 to provide past interaction information, and an icon 5160 to allow the initiating user to initiate a social network by sending a message to the target user.

If the initiating user chooses to select icon 5160 to initiate a social network by sending a message to the target user, they are directed to a message screen, where they are permitted to initiate a social network with the selected target user by sending the target user a message. A message screen includes a tag 5210 identifying the target user to whose personal mobile device the message will be sent, and includes a message entry box 5220 and a send icon 5230 for the initiating user to use in entering and sending a message. The message may include or more of text, an image, a video clip, or an action such as a nudge. If the initiating user chooses to send an image or video clip they may be directed to use their device's camera or select from a library, such as a library stored locally on their device or a library accessed using the Internet.

When the initiating user has sent a message to a target user, the target user may be notified of the message in much the way they are notified of any other message received on their personal mobile device and may be permitted to review the message in combination with profile information about the imitating user, such as one or more of a user name, photo, or profile comment, and may be permitted to decide whether to respond. In some embodiments, if a target user is not interested in participating in the social network they can simply ignore any incoming messages from the initiating user, such as for a period of one minute, with the result that the initiating user is blocked from sending further messages to the target user.

An example of a message screen that would be seen by Target User 3 upon receiving a message from Initiating User 1 is shown in FIG. 5C. As shown, Target User 3 is notified via notification 5300 that if they wish to stop receiving communications, they can simply ignore the message. They are also notified that if they wish to continue the communication they can simply reply. Just like the initiating user, the target user may choose to review the initiating user's profile prior to deciding how to proceed or may simply proceed with a communication.

As shown in FIG. 5D, if a user does not wish to receive communications from another user, they may choose to block that other user using options icon 5400 and selecting block icon 5410, although they could also mute notifications using mute icon 5420 or may choose to take other less final steps to reduce the intrusion of messages from that other user. Options icons such as options icon 5400 may also be provided when a user is reviewing another user's profile, such as indicated in FIG. 5A.

If a user chooses to block another user, they may be presented with a block options screen, such as the block options screen shown in FIG. 5E. A block options listing 5500 may allow the user to choose whether they wish to simply block the other user, or to provide some reason, such as to flag an issue for review by a system administrator.

If a user has been blocked by another user, a notification such as notification 5600 of FIG. 5F may be displayed.

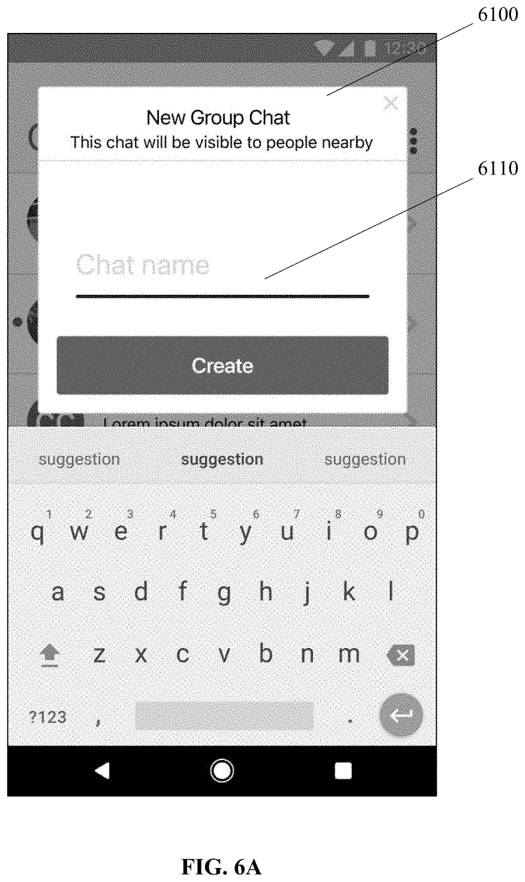

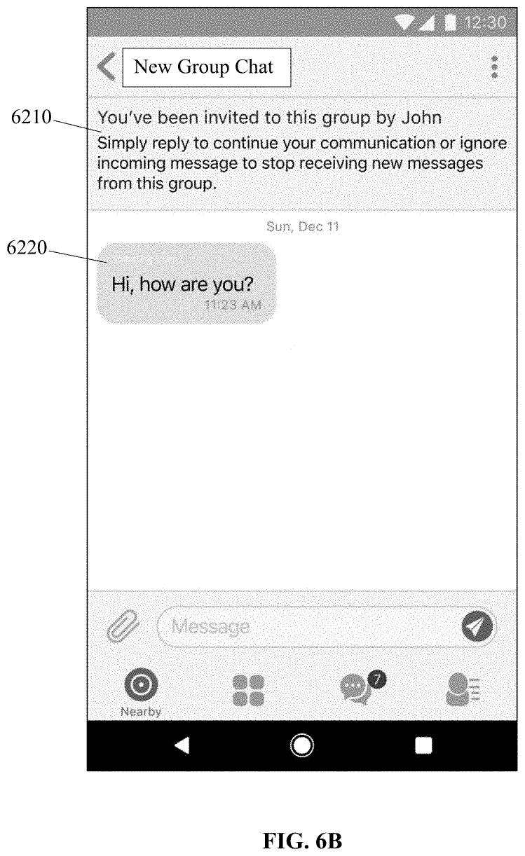

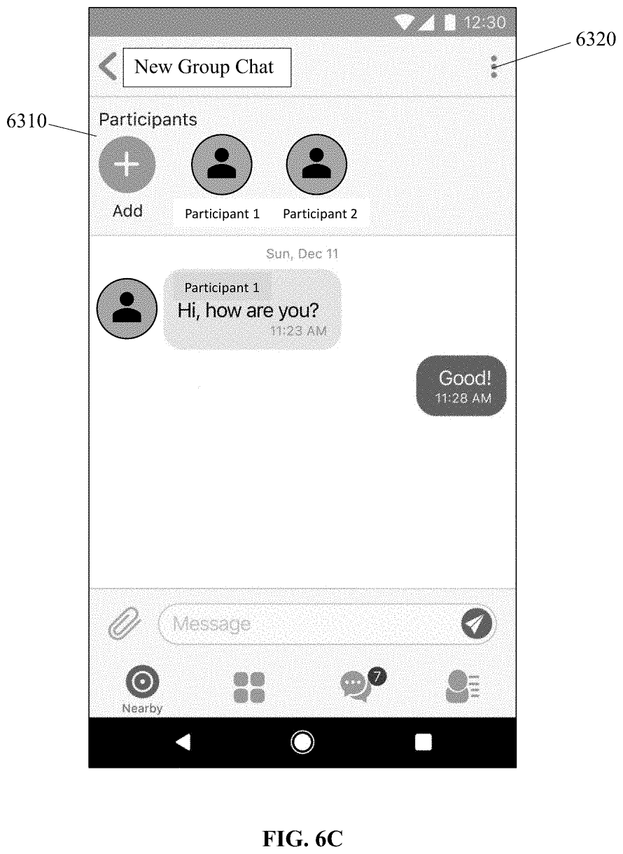

As indicated in FIGS. 6A to 6C, group chats may also be initiated. As shown in FIG. 6A, an initiating user may be provided with a group chat formation entry form 6100, which prompts the initiating user to enter a name for the chat in name box 6110 and may also prompt the user to add other details. For example, the initiating user may wish to have the chat visible generally to everyone within a threshold distance, or may wish to include only a certain subset of those nearby, or may wish to add or remove other participants who are not nearby.

Where a nearby user has been invited, either selected particularly or simply invited based on a general invitation to nearby users, they may be able to access a group chat screen such as shown in FIG. 6B. A group chat screen may include a notification 6210 that the user is invited to join a group chat and how to participate or stop receiving messages. The group chat screen may show an initiating message 6220, which may indicate such details as the name of the user who sent the message.

As indicated in FIG. 6C, a group chat screen may also include chat member details in a chat participants notification 6310, which may also provide a user with the option of adding a participate, such as a nearby user or a user from a contact list, using add icon 6311. The group chat screen may also include an options icon 6320, similar to the options icon 5400 of FIG. 5D.

In some embodiments, group chats are conducted as standard peer-to-peer connections. For example, in some embodiments all devices are responsible for sending and saving all messages.

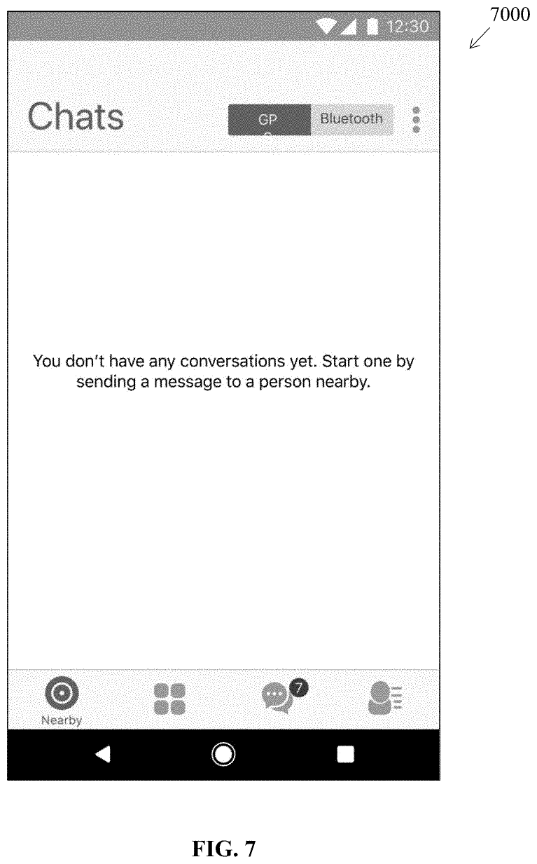

FIG. 7 shows a screenshot 7000 of a chats summary screen, showing summaries of all chats that a user has participated in or is participating in. A chats summary screen may in some embodiments be accessed via messages icon 5430.

A chats summary screen may enable a user to continue to carry on a conversation or maintain a social network after the other user or user is no longer nearby. A chats summary screen may take the place of, or may complement, a contact list of known users.

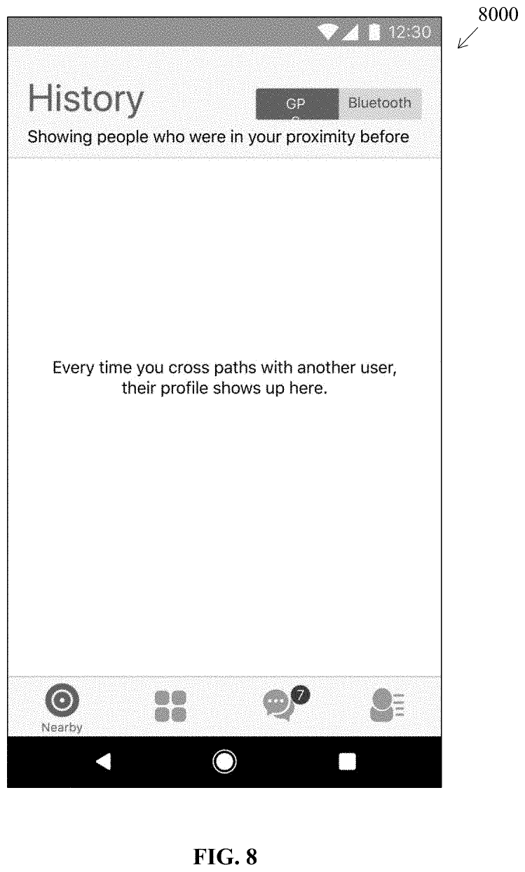

Another way of tracking past contact, such as to initiate or maintain a social network, is by using a history summary screen. Screenshot 8000 of FIG. 8 shows a history summary screen which may be used by a user to track who they have crossed paths with. In some embodiments, the list of people the user has encountered may be limited to encounters within a set timeframe, such as the last two days. The history summary screen may be automatically populated as the networking system detects nearby potential target users.

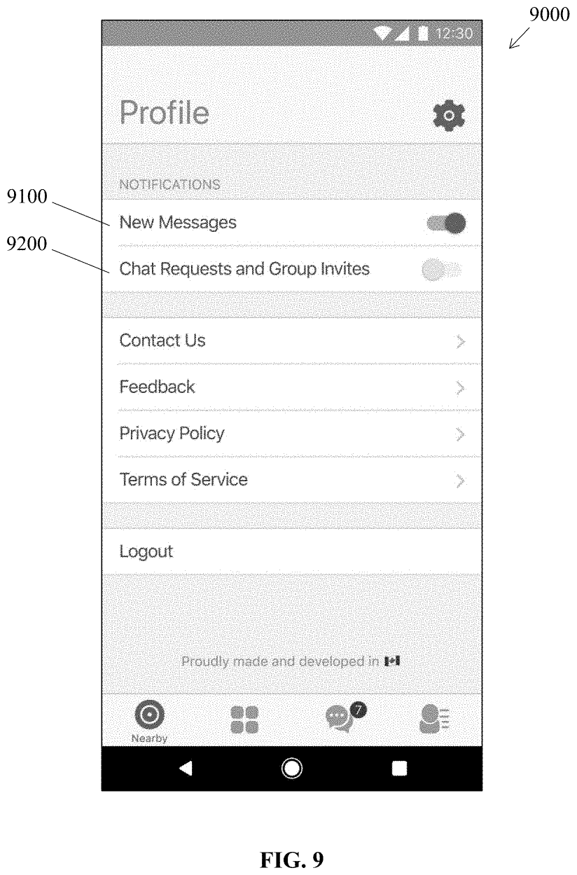

Screenshot 9000 of FIG. 9 shows a profile settings screen, allowing a user to modify profile settings. For example, a new messages notification toggle 9100 allows users to set whether they will be notified of a new message, while chat requests and group invites toggle 9200 allows a user to set whether to be notified of a chat request or group invite. Such notification settings can be set to adjust the extent to which the user wishes to be notified of potential social networking opportunities, such as if a user decides that they are not interested in meeting nearby potential contact users and does not wish to be the target user of an initiating user.

In some embodiments, the networking system is made available to a potential user via a mobile application download. Downloading the application and signing in allows the user to be discovered by other users of the application in their proximity, or to discover other users of the application in their proximity. In some embodiments, once two users have discovered one another they can freely communicate or chat, even after they are no longer proximate.

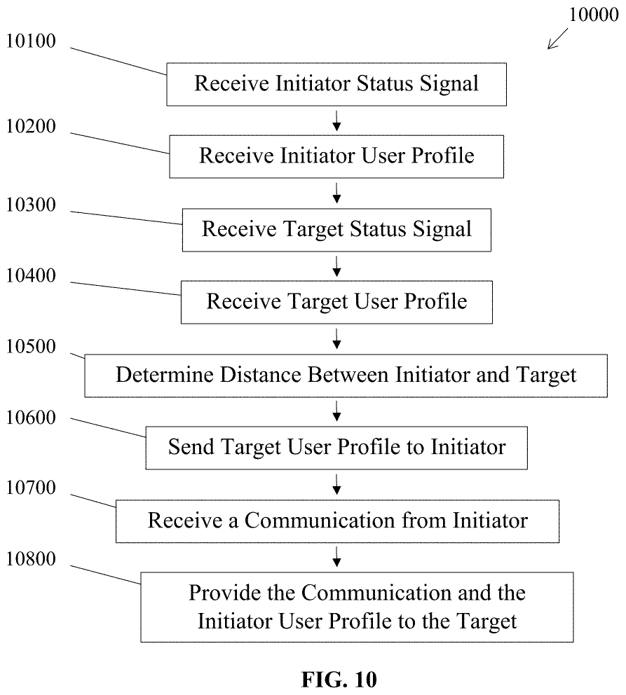

As depicted in FIG. 10, embodiments of social networking engines include a series of steps 10000. The series of steps includes receiving an initiator status signal 10100 from an initiator device, the initiator status signal indicating that the initiator user in control of the initiator device is interested in forming a social network with one or more nearby individuals who are also interested in forming a social network with those near them. An initiator user profile is also received 10200, the initiator user profile providing a name or photo or other identifying information that could give a target user some idea of who it is that is sending them a message. The use of profiles may be to allow users to recognize other user among the people around them or simply to introduce a level of personalization which may encourage users to participate in a social network with other users.

The series of steps 10000 of the social networking engine also includes receiving one or more target status signals 10300 from the target devices of target users, the target status signals indicating that the corresponding target user has an ongoing interest in forming new social networks with nearby individuals. The social networking engine also receives a target user profile 10400 for each target user device. The social networking engine determines that the target user and the initiator user are within a threshold distance of each other 10500, such as a range of a short-range radio transceiver in some embodiments, and sends one or more target user profiles 10600 to the initiator user device. In many embodiments sending target user profiles also includes sending other information, such as the direction and distance to each target user.

If an initiator user decides to initiate a social network with one or more identified target users, the series of steps includes receiving a communication from the initiator user 10700 directed to one or more of the target users, and the social networking engine will then provide the communication and the initiator user profile to the identified target user or users 10800. The target user or users may then decide whether or not to respond to the communication.

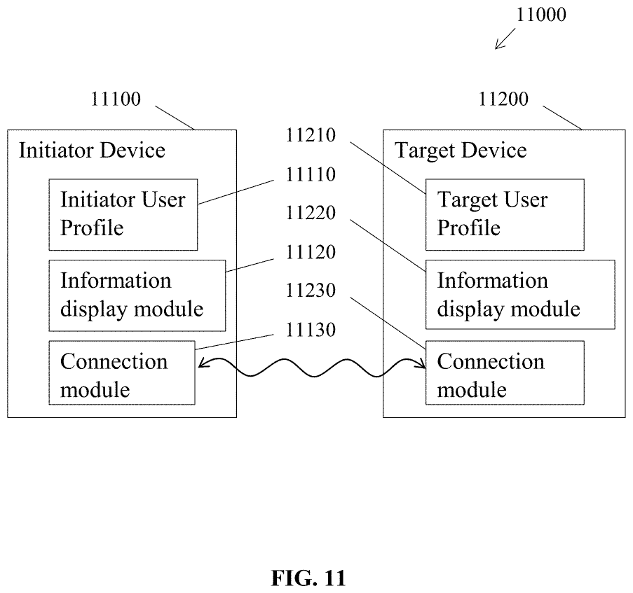

In some embodiments a system, such as system 11000 of FIG. 11, may be employed. System 11000 includes an initiator device 11100 and a target device 11200, each associated with a user profile, 11110 and 11210 respectively. Each of the initiator device and the target device includes an information display module, 11120 and 11220 respectively, to communication information received to users of the devices.

Each of the initiator device and the target device includes a connection module, 11130 and 11230 respectively, provided to permit the devices to detect and communicate with other devices, such as other devices in the area. In some embodiments, the connection modules each include a radio transceiver to detect and communicate directly with a radio transceiver of another device, such as to allow the radio transceiver of the initiator device to communicate directly with the radio transceiver of the target device. In some embodiments, the connection modules monitor the area within a threshold distance of their respective devices for other devices which provide a signal indicating an availability to form new social networks based on proximity. In some embodiments the threshold distance is the range of the respective radio transceivers, such as radio transceivers implementing Bluetooth communications protocols.

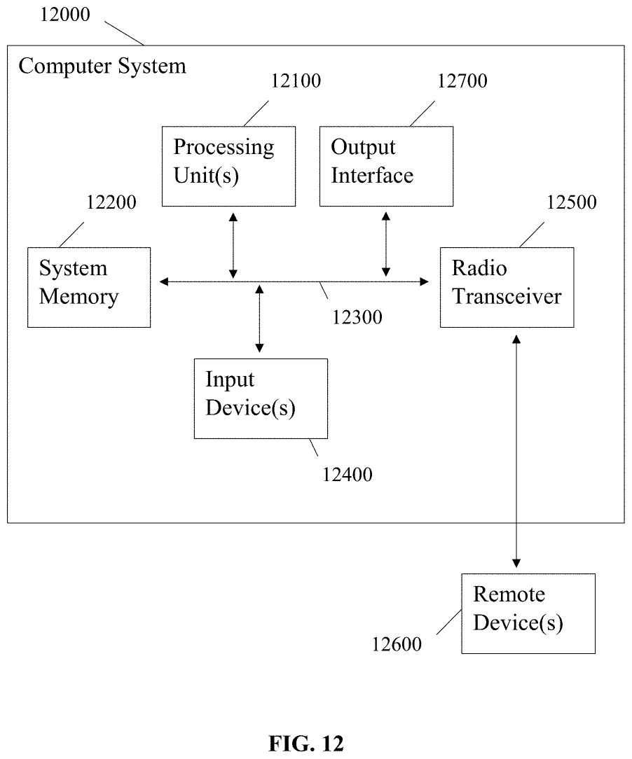

Embodiments of the present invention may be implemented using computer systems or devices, such as the computer system depicted in FIG. 12, which may in preferred embodiments be personal mobile devices such as smartphones or tablet computers. The computer system may execute computer instructions to perform steps involved in determining distance, detecting other devices, retrieving and presenting profile information, sending messages, and other processing related to embodiments of the present invention.

As depicted in FIG. 12, a computer system 12000 used in implementing embodiments of the present invention includes a processing unit 12100 and a system memory 12200, which may be interconnected across a system bus or network 12300. The computer system may have access to computer readable media, and the system memory may include computer readable storage media in the form of volatile and/or non-volatile memory such as read only memory and/or random-access memory. In some embodiments system memory may include an operating system, application programs, and program data.

A user using the computer system depicted in FIG. 12 may interface with the computer through input devices 12400, such as a mouse or touchpad, to provide information and instructions. The computer system also includes a radio transceiver 12500 for sending and receiving radio communications, such as radio communications to and from remote devices 12600 such as other computer systems. The computer system also includes an output device 12700 to allow a user to receive information from the system, such as a display or network or output interface. In some embodiments a computer system may be networked and operable as a distributed system, a computer compilation system may also be able to access distributed databases for information or processing capability.

Some embodiments may be implemented as a system, a method, or a computer program product. Accordingly, aspects of the invention may take the form of an entirely hardware embodiment, an entirely software embodiment (such as including firmware and resident software) or an embodiment combining software and hardware aspects. Aspects of some embodiments may take the form of a computer program produced embodied in one or more computer readable media having computer readable program code embodied therewith.

Various embodiments of the invention have been described in detail. Since changes in and or additions to the above-described best mode may be made without departing from the nature, spirit or scope of the invention, the invention is not to be limited to those details but only by the appended claims.

What is claimed is:

1. A method of forming a social network, comprising:
receiving an initiator status signal from an initiator device, the initiator status signal indicating interest in forming the social network;
receiving an initiator user profile of an initiator user, the initiator user profile associated with the initiator device;
receiving a target status signal from a target device, the target status signal indicating ongoing interest in receiving notifications about potential new social networks;
receiving a target user profile of a target user, the target user profile associated with the target device;
determining that a distance between the initiator device and the target device is less than a threshold;
sending the target user profile to the initiator device to be reviewed by the initiator user;
receiving a social network communication from the initiator device directed to the target device; and
providing the social network communication to the target device along with the initiator user profile.

2. The method of claim 1, wherein the social network communication is a chat communication.

3. The method of claim 2, wherein the initiator device is a cell phone, a smartphone, or a computer and wherein the target device is a cell phone, a smartphone, or a computer.

4. The method of claim 1, wherein the initiator and target devices each include a radio transceiver for determining that the distance between the initiator device and the target device is less than a threshold.

5. The method of claim 4, wherein radio transceivers are short-range low-power radio transceivers and determining the distance includes using the radio transceiver of the initiator device to directly detect the radio transceiver of the target device, the threshold being the range of the radio transceiver of the initiator device.

6. The method of claim 1, further comprising:
monitoring the target device for a threshold time for a reply communication; and
blocking the initiating device from sending a further communication to the target device if no reply communication is received within the threshold time.

7. The method of claim 1, further comprising:
receiving a block message from the target device; and
blocking the initiating device from sending a further communication to the target device.

8. The method of claim 7, further comprising providing a block notification to the initiating device to notify the initiating user that they are blocked from sending the further communication to the target device.

9. The method of claim 1, wherein sending the target user profile to the initiator device to be reviewed by the initiator user further includes sending to the initiator device the distance and a direction to the target device.

10. The method of claim 1, wherein the target device is a set of target devices and the target user profile, the target user, and the target status signal are corresponding sets of target user profiles, target users, and target status signals.

11. The method of claim 1, further comprising:
receiving a tertiary status signal from a tertiary device, the tertiary status signal indicating ongoing interest in receiving notifications about potential new social networks;
receiving a tertiary user profile of a tertiary user, the tertiary user profile associated with the tertiary device;
determining that a distance between the initiator device and the tertiary device is less than the threshold;
sending the tertiary user profile to at least one of the initiator devices and the target device;
receiving a joining communication from one of the initiator device and the target device directed to the tertiary device, the joining communication inviting the tertiary user to join the social network; and
providing the joining communication to the tertiary device along with the initiator user profile and the target user profile.

12. The method of claim 1, further comprising:
accessing an initiator history storage to locate a tertiary user profile;
providing the tertiary user profile to the initiator device;
receiving a joining communication from the initiator device directed to the tertiary device, the joining communication inviting the tertiary user to join the social network; and
providing the joining communication to the tertiary device along with the initiator user profile and the target user profile.

13. A method of forming a social network, comprising:
receiving from an initiator device an initiation signal indicating an interest in forming the social network;
receiving an initiator user profile of an initiator user, the initiator user profile associated with the initiator device;
monitoring a target area around the initiator device to detect a target device indicating ongoing interest in forming new social networks and located within the target area, the target area bounded by a threshold distance from the initiator device;
notifying the initiator user of the target device and providing the initiator with a target user profile associated with the target device; and
transmitting an initiating communication from the initiator device to the target device.

14. The method of claim 13, wherein the initiator and target devices each include a radio transceiver, and detecting a target device includes the radio transceiver of the initiator device directly detecting the radio transceiver of the target device.

15. The method of claim 14, wherein the radio transceivers are short-range low-power radio transceivers and the threshold distance is a range of the radio transceiver of the initiator device.

16. A system for social networking, comprising:
a radio transceiver for sending and receiving a set of radio transmissions;
a display for displaying system notifications to a user;
a storage for storing the set of radio transmissions; and
a processor configured to direct the radio transceiver to search for a target device indicating an availability to form a social network and located within a threshold distance of the radio transceiver, the processor further configured to retrieve target user profile information and provide the target user profile information to the display.

17. The system of claim 16, wherein the processor if further configured to receive a communication from the user and transmit the communication to the target device directly using the radio transceiver.

18. The system of claim 17, wherein the radio transceiver is a short-range low-power radio transceiver.

19. The system of claim 18, wherein the threshold distance is a range of the radio transceiver.

20. The system of claim 16, wherein the radio transceiver is configured to detect a direction to the target device to be provided to the display.
